(19) United States
(12) Patent Application Publication
(10) Pub. No.: US 2020/0062865 A1
(43) Pub. Date: Feb. 27, 2020

(54) SPHERICAL CELLULOSE NANOPARTICLES AND PROCESS FOR PREPARATION THEREOF

(71) Applicant: 9802622 CANADA INC., HAMPSTEAD (CA)

(72) Inventor: JOHN HA-THANH LUONG, MONTREAL (CA)

(21) Appl. No.: 16/344,131

(22) PCT Filed: Oct. 17, 2017
(86) PCT No.: PCT/CA2017/051230

§ 371 Date: Apr. 23, 2019

Related U.S. Application Data
(60) Provisional application No. 62/412,325, filed on Oct. 25, 2016.

(51) Int. Cl. C08B 37/08; C08B 15/02; C08B 15/08; C08L 1/04; C01B 15/08

(52) U.S. Cl. CPC C08B 37/003; C08B 15/02; C08B 15/08; B82Y 30/00; C01B 15/08; C08L 2205/18; C08L 1/04

(57) ABSTRACT

The disclosure relates to spherical crystalline cellulose nanoparticles (SCCNPs) and a process for producing same from cellulosic material; wherein said process comprises contacting a cellulosic material with an Oxone monopersulfate reagent.

### FIELD OF THE DISCLOSURE

This disclosure relates to spherical crystalline cellulose nanoparticles (SCCNPs) and a process for producing same from cellulosic materials.

### BACKGROUND OF THE DISCLOSURE

Cellulose is a polysaccharide consisting of a linear chain of β(1→4) linked D-glucose units with a molecular formula as (C₆H₁₀O₅)n. Hydroxyl groups of cellulose are involved in a number of intra- and intermolecular hydrogen bonds, resulting in various ordered crystalline arrangements (Scheme 1).

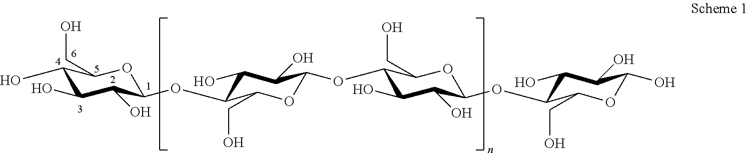

In scheme 1, n represents the degree of polymerization (DP). The n value is in the range of 300 to 700 units. DPs of cellulose materials vary depending on the source, production process, and treatment. DP values range from 100-3000 for commercial celluloses to 20,000 for cotton fiber secondary walls to 44,000 for Valonia (a species of algae).

The beta-1,4 glycosidic bonds per se are not too difficult to break. However, owing to intra- and intermolecular hydrogen bonds, cellulose can form very tightly packed crystallites to prevent the penetration of chemicals, enzymes, and even water. As the most abundant polymer, cellulose is present in plants, tunicates, algae, and some bacteria. Wood has 40-50% cellulose, compared to 90% for cotton fibers and 99% for bacterial cellulose produced by Acetobacter xylinum or Gluconacetobacter xylinus.

Cellulose fibers are formed by microfibrils; flexible hair strands composed of elementary fibrils. Such elementary fibrils formed during cellulose biosynthesis consist of 30 to 100 aggregated cellulose chains. Thus, elementary fibrils (also known as nanofibrils or nanofibers) are about 2-20 nm in diameter and a few micrometers in length with two distinct regions: crystalline and amorphous where the cellulose chains are arranged in highly ordered and disordered (amorphous) structures.

When subjected to acid hydrolysis (Revol et al., Int. J. Biol. Macromol., (1992) 14, 170-172,) or strong oxidation, particularly with ammonium persulfate (Leung et al., Small, (2011) 7(3), 302-305, 2011; Lam et al., Sustainable Chem. Eng., (2012) 1(2), 278-283,), cellulose microfibrils undergo transverse cleavage along the amorphous regions, resulting in the formation of crystalline nanocellulose crystals (CNCs) with a rodlike shape. CNCs have been attempted for diversified applications, and different production methods have been described in the literature.

The synthesis of spherical cellulose particles has been reported by Zhang et al. Carbohydrate Polymers, (2007) 69, 607-61. This procedure involves two concentrated acids (12.1 N HCl and 36.0 N H₂SO₄) and ultrasonication at 80° C. for eight hours, followed by centrifugation with continuous washings using deionized water, and neutralization with 2.00 N NaOH. The neutralized product is further washed with water, dialyzed and freeze-dried. The procedure results in cellulose nanospheres with sizes ranging from 60 nm to over 570 nm and the hydrolyzed nanocelluloses are predominantly cellulose II polymorphic crystalline structure.

### SUMMARY OF THE DISCLOSURE

One aspect of the disclosure relates to a process for producing spherical crystalline cellulose nanoparticles (SCCNPs) comprising contacting a cellulosic material with an effective amount of a reagent comprising potassium peroxomonosulfate (KHSO₅).

One aspect of the disclosure relates to a nanosized cellulose particle, wherein the said particle is substantially spherical crystalline cellulose nanoparticles (SCCNPs) and said SCCNPs have an average diameter of about 3-10 nm or less as assessed by transmission electron microscope (TEM) micrographs.

One aspect of the disclosure relates to a substantially spherical crystalline cellulose nanoparticles (SCCNPs) prepared by the process as defined herein.

### BRIEF DESCRIPTION OF THE DRAWINGS

The present disclosure is illustrated with reference to the accompanying drawings, in which:

FIG. 1(A) is transmission electron microscope (TEM) micrographs of SCCNPs after microcrystalline cellulose was treated with Oxone® having a reference scale of 0.5 μm;

FIG. 1(B) is transmission electron microscope (TEM) micrographs of SCCNPs after microcrystalline cellulose was treated with Oxone® having a reference scale of 200 nm;

FIG. 1(C) is transmission electron microscope (TEM) micrographs of SCCNPs after microcrystalline cellulose was treated with Oxone® having a reference scale of 100 nm;

FIG. 1(D) is transmission electron microscope (TEM) micrographs of SCCNPs after microcrystalline cellulose was treated with Oxone® having a reference scale of 50 nm;

FIG. 2 is an AFM micrographs of SCCNPs after microcrystalline cellulose was treated by Oxone® and deposited on a Si wafer (Left), a closer view is displayed on the Right;

FIG. 3 depicts the XRD diffractograms of pristine microcrystalline cellulose and SCCNPs in accordance with the present disclosure;

FIG. 4 depicts the XRD diffractogram of pristine microcrystalline cellulose: green curve; and the result of treatment with Oxone® after 2 hours: red curve and after 4 hours: blue curve;

FIG. 5 depicts a solid state 13 C NMR of microcrystalline cellulose and SCCNPs in accordance with the present disclosure; and

FIG. 6 depicts an FTIR spectrum of SCCNPs in accordance with the present disclosure.

### DETAILED DESCRIPTION OF THE DISCLOSURE

The present disclosure describes a process for producing substantially spherical crystalline cellulose nanoparticles (SCCNPs) by contacting a cellulosic material with a sufficient amount of the oxidizing agent.

The process is conducted in an aqueous medium. The reagent is dissolved in the aqueous medium (preferably in water alone) at a concentration ranging from about 0.20 M to about 1.25 M, or alternatively is 0.25 to 1.2 M, with the resulting pH of below about 2. The preferable concentration of the reagent is about 1 M with a corresponding pH of about 1.

The concentration of the cellulosic material in the aqueous medium can range from about 0.1 to about 2.5 wt/vol %, or about 0.2% to about 1 wt/vol %, or preferably is about 0.5 wt/vol % or higher. The amount is not over about 2.5 wt/vol % due to the gelation of the cellulosic material when the aqueous medium is subject to a temperature ranging from about 45-80° C.

The preferable ratio of the cellulosic material to the reagent (weight percentage) is about 1:1 to about 1:10; about 1:2 to about 1:10; 1:2 to 1:5 or 1:2 to 1:3.

The process is preferably conducted at a temperature, ranging from about 40° C. to about 80 ° C. with constant stirring. The preferable temperature is 60 ±5° C.

The process is preferably conducted at a temperature, ranging from about 40° C. to about 80° C. with constant stirring. The preferable temperature is 60±5° C.

The preferable contacting time between the cellulosic materials with the oxidizing agent is from about 8 hours to about 16 hours. The time may be lower, for example, 2-4 hours, if the temperature and/or Oxone® concentration is (are) above the minimum amounts described in the ranges previously described.

The resulting spherical crystalline cellulose nanoparticles (SCCNPs) may be recovered by any suitable method, including centrifugation, filtration and/or settling and decanting.

The resulting SCCNPs may further be dried by vacuum, freeze drying, or oven drying to form dried SCCNPs.

The present disclosure also produces carboxylic acid groups on the surface of spherical crystalline cellulose nanoparticles (SCCNPs). During the oxidation step, selective oxidation preferably occurs at the C6 primary hydroxyl group of the glucose ring to form carboxylic acid groups with a degree of oxidation (DO) of from 0.005 to 0.010 or 0.04 to 0.10.

Spherical crystalline cellulose nanoparticles SCCNPs have an average diameter of about 3-10 nm or less as assessed by transmission electron microscope (TEM) micrographs, depending the contacting time. As prepared SCCNPs with carboxylic groups can be neutralized with sodium hydroxide, potassium hydroxide or ammonium hydroxide to enhance water solubility and dispersion.

Spherical crystalline cellulose nanoparticles (SCCNPs) exhibit a similar crystallinity index (CRI), compared to microcrystalline cellulose, one of the substrates used for the preparation of SCCNPs. Advantageously, the CRI may be at least 10% greater than the CRI of the starting cellulosic material such as carton board and wood pulp.

In brief, the present process describes a procedure for producing SCCNPs with substantially similar or enhanced uniformity and crystallinity compared to the starting raw material. In contrast, both acid hydrolysis and ammonium persulfate oxidation produce rodshaped like materials. The present disclosure presents a new methodology of green chemistry, which uses an inexpensive reagent, and may even use, in certain embodiments, water as the sole aqueous medium, for the reaction and purification steps. The reaction is carried out at a temperature no higher than about 80° C. The waste product, potassium sulfate, resulting from the process, is a non-flammable white crystalline salt that is commonly used in fertilizers, providing both potassium and sulfur.

Spherical crystalline cellulose nanoparticles (SCCNPs) produced by the present process are carboxylated, which renders them more water soluble and amenable to bioconjugation for the synthesis of bionanocomposites. Biodegradable SCCNPs with biocompatibility, non-toxicity, and renewability will foster a plethora of diversified applications such as drug delivery, biosensing/bioimaging, pharmaceutical formulation, cosmetics, food, textiles, aerogels, etc. Cellulose nanoparticles degrade faster than metallic nanoparticles or carbon-based materials such as fullerenes and carbon nanotubes. SCCNPs are expected have low toxicity and low environmental risk, which are significantly lower than those for carbon nanotubes and other fibers. Thus, their applications for biomedical applications are promising towards the production of implants, face masks, drug delivery, cell carriers, artificial blood vessels, etc. They may be decorated with antimicrobial agents for applications in wound dressing, bandage, and hygienic products.

As used herein, the expression “cellulosic material” refers to suitable cellulose fibers with high initial cellulose contents such as MCC, cotton fibers, bacterial cellulose, etc. can be used. The use of MCC is a particular challenge due to its high crystallinity, which is less vulnerable to chemical or enzymatic attacks In this disclosure, any cellulose-based materials can be used as starting material, (e.g., Avicel) with different particles sizes or native cellulose fibers to produce nanosized cellulose particles.

As used herein, the reagent is comprising potassium peroxomonosulfate (KHSO₅). Oxone®, for example, is a tri-salt comprising KHSO₅.0.5 KHSO₄.0.5 K₂SO₄ (MW=307.38), has the active component potassium peroxomonosulfate (KHSO₅) as the oxidant. Oxone® is soluble and stable in water. At 20° C., the solubility of Oxone® in water is 277 g/L or 0.9 M. At 60° C. (140° F.), the solubility of Oxone® is about 387 g/L or 1.26 M.

In one embodiment, the reagent is comprising the tri-salt KHSO₅.0.5 KHSO₄.0.5 K₂SO₄.

In one embodiment, the reagent is consisting essentially (or consisting) of the tri-salt KHSO₅ .0.5 KHSO₄.0.5 K₂SO₄.

As used herein, the expression “aqueous medium” refers a process reaction medium comprising water. In one embodiment, the aqueous medium is water as the sole component.

### EXAMPLES

Oxone® monopersulfate (KHSO₅.0.5 KHSO₄.0.5 K₂SO₄) and Avicel® PH-101 (20 to 50 μm in diameter) were obtained from Sigma-Aldrich. Avicel® has been known as microcrystalline cellulose with high crystallinity.

Preparation of crystalline cellulose nanoparticles. Avicel® PH-101 (0.2-1 g) was added to a 1 M Oxone® aqueous solution (100 mL, pH 1). The suspension was heated to 60° C. with vigorous stirring for up to 14-16 h to give a white suspension. The suspension was centrifuged (10,000 rpm) for 15 min. The supernatant was decanted, and about 50 mL of deionized water was added to the pellet, followed by 5 min of vigorous mixing. The centrifugation/washing cycles were repeated 5 times until the solution pH of 7 was reached. The product was placed in a vacuum chamber overnight to give a white powder. During the treatment of Avicel® with Oxone®, selective oxidation was effected at the C6 primary hydroxyl group of the glucose molecule subunit to form carboxylic acid groups. The Oxone® was effective in cleavage of the glycosidic bonds and etching out individualization of elementary fibrils to form crystalline cellulose nanoparticles.

Transmission electron microscopy (TEM) was performed by the Transmission Electron Microscope, JEM-1400, JEOL, equipped with a Bottom CCD 2×2k camera. For TEM imaging, the particle-containing sample was dispersed in deionized water and subject to bath sonication. Three small droplets from the resulting suspension were then applied on a carbon-coated copper TEM grid and vacuum dried in a covered plastic dish.

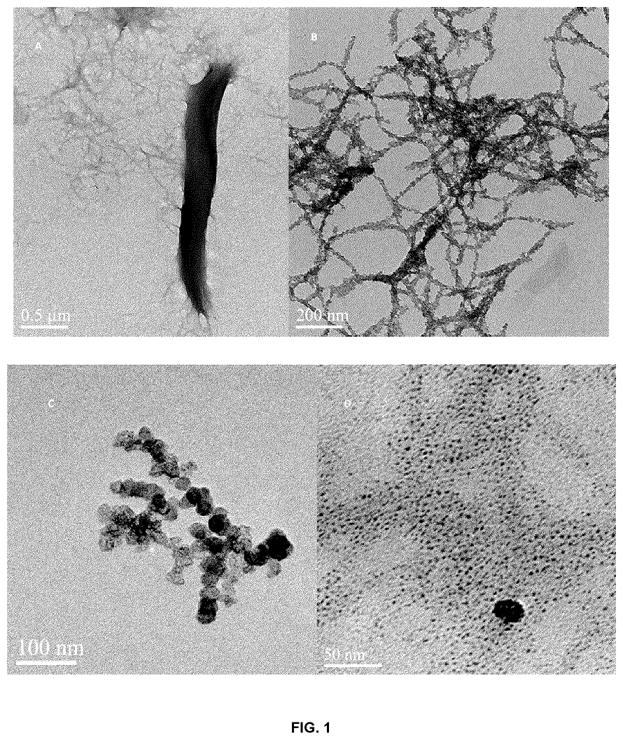

FIG. 1 depicts transmission electron microscope (TEM) micrographs describing the fate of Avicel®, PH-101 treated with 1 M Oxone® as shown in FIG. 1. (A) The TEM micrograph shows the oxidation and etching capability of Oxone® to hydrolyze the β(1-4) bonding of microcrystalline cellulose (20-50 μm) to form shorter fibers (<0.5 μm in diameter and 5 μm in length and then smaller fibers. (B) A close look at such fibers revealed the formation of spherical nanoparticles. (C) Nanoparticles are formed on the fiber surface, about 25 nm in diameter and (D) such nanoparticles consist of smaller nanoparticles, about 3-5 nm in diameter. It was reasoned that the active potassium peroxymonosulfate (KHSO₅) first attacked the terminal glucosidic bond of the cellulose chain to loosen up the crystallites to allow the penetration of water and Oxone®. Like acids, KHSO₅ was capable of hydrolyzing the β(1→4) bonds, and the presence of water renders each broken bond inactive.

The X-ray diffraction (XRD) pattern was probed by a Bruker D8 Advance or with Philips PW1050 X-ray diffractometer (Cu Kα radiation, operating at 40 kV/30 mA with a 0.0019 step size and a 0.5 s step). The collected XRD data were analyzed using FullProf to provide peak position (2θ, 2theta), FWHM (full-width half maximum), peak deconvolution, and integration intensity for the estimation of the crystallinity index (CRI). Crystallite sizes were determined by the Scherrer equation as K λ/(FWHM. cos θ) with the Scherrer constant (K) 1 and λ=1.542 A. The d_{hkz}-spacing is calculated as λ/2 sin θ

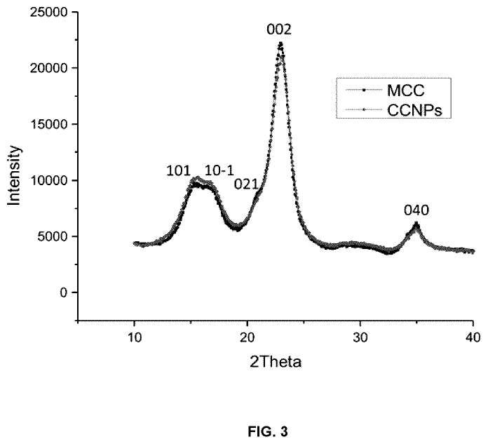

FIG. 3 depicts the XRD diffractograms of pristine Avicel®, PH 101 and the resulting crystalline cellulose nanoparticles (CCNPs) from the treatment with 1 M Oxone® for 12 hours at 60° C. The XRD diffractogram of pristine Avicel®, PH-101 exhibited the most intense peak (002) with a shoulder (021) and two lower peaks (101 and 10-1), besides a very small peak (040) at 2θ=35°. As shown in FIG. 3, this is a typical XRD signature of cellulose I. The intensity of the amorphous reflection at a 2θ angle of about 18°, corresponding to the minimum intensity between the (10-1) and (021) plane signals. The CCNPs exhibited a virtually identical XRD diffractogram with respect to the peak positions, compared to the pristine MCC. However, the intensity of the (021) peak was slightly smaller, compared to that of the pristine Avicel®. In contrast, the intensities of the two peaks (101 and 10-1) of the crystalline cellulose nanoparticles were slightly higher than those of the pristine Avicel®.

Detailed analysis of the XRD diffractograms of Avicel® and crystalline cellulose nanoparticles is summarized in Table 1.

TABLE 1
Detailed analysis of the XRD diffractograms of Avicel ® and
crystalline cellulose nanoparticles using Fullprof

| | | | Crystalline cellulose | |
|---|---|---|---|---|
| Parameters | Pristine Avicel ® | | nanoparticles | |
| Average apparent size (Å) | 46.70 | (SD: 0.65) | 47.43 | (SD: 0.65) |
| Maximum strain (Å) | 466 | (SD: 124) | 464 | (SD: 125) |
| d-spacing (Å) | | | | |
| peak 101 | 5.80 | (2θ = 15.25) | 5.91 | (2θ = 14.97) |
| peak 10-1 | 5.19 | (2θ = 17.05) | 5.24 | (2θ = 16.90) |
| peak 021 | 4.26 | (2θ = 20.82) | 4.31 | (2θ = 20.61) |
| peak 002 | 3.87 | (2θ = 22.96) | 3.89 | (2θ = 22.85) |
| peak 040 | 2.57 | (2θ = 34.93) | 2.58 | (2θ = 34.68) |

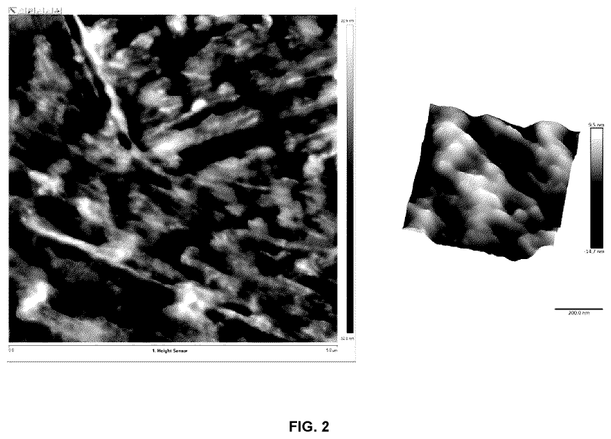

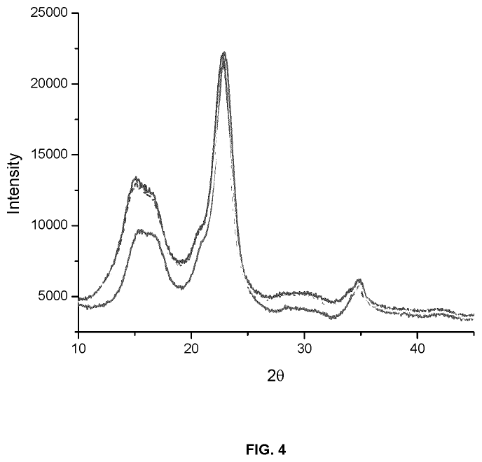

An XRD was then used to follow the change in diffractogram of Avicel® during the course of treatment with the Oxone® oxidant. As shown in FIG. 4, after 2-4 hours of the treatment, the peak intensities observed for (101) and (10-1) increased appreciably, corresponding to a noticeable decrease in the peak intensity for (040). The amorphous part of the cellulose at 2θ close to 19° also increased significantly. Such results were expected considering the chemical attack of Oxone® that cleaved the cellulose microfibril and oxidized the glucose molecule at C6 position. During this period, the cellulose chains were re-arranged in noticeably disordered (amorphous) structures. Such amorphous parts were then cleaved by Oxone® with prolonged treatment up to 12 hours, resulting in crystalline cellulose nanoparticles as shown in FIGS. 1-2. The amorphous part was water soluble and then removed during the repeated centrifugation and washing steps.

The crystallinity index (CRI) of the pristine Avicel® and crystalline cellulose nanoparticles was estimated to be 84.87% and 83.51%, respectively. It should be noted that the CRI value of Avicel® is dependent upon the analytical procedure and calculation method (Park et al., Biotechnol. Biofuels. (2010) 3:10. 10.1186/1754-6834-3-10). This value could range from above 55% to over 95% (Kamaouri et al. J. Phys. Chem. B. (2016) 120, 309-319). However, the CRI value obtained for the Avicel® PH-101 using the same calculation procedure was in agreement with the result reported by Leung et al. in publication US 2012/0244357. The estimation is based on the crystalline peak area over the total peak area (crystalline area plus amorphous area). The peak height method for the estimation CRI, proposed by Segal et al. (Text. Res. J. (1959), 29, 786-794) is less applicable in this case (CRI=I₀₀₂/(I₀₀₂−I_{Amor}) owing to the increase of the (101 and 10-1) peaks as mentioned previously. I₀₀₂ is the at peak intensity at a 2θ angle close to 22° representing the crystalline part and I_{Amor} is the peak intensity at 2θ close to 19° representing the amorphous part of the cellulose.

Atomic force microscopy (AFM) was performed by AFM Icon (Bruker) for imaging spherical cellulose nanoparticles using a silicon tip operated in tapping mode. In corroboration with TEM, atomic force microscopic (AFM) imaging was also conducted to show the synthesis of spherical cellulose nanoparticles by Oxone®. FIG. 2 is showing AFM micrographs of Avicel®l PH-101 after being treated by 1 M Oxone® for 12 hours at 60° C. The sample was sonicated and deposited on a Si wafer. (Left) the formation of spherical cellulose nanoparticles on each fiber (Right) a close-up view of spherical cellulose nanoparticles.

Attenuated Total Reflection (ATR)-FTIR is performed using pristine Avicel® PH-101 and the vacuum-dried powder of crystalline cellulose nanoparticles (Bruker Optics, Billerica, Mass., USA, FT-IR spectrometer equipped with a diamond tip).

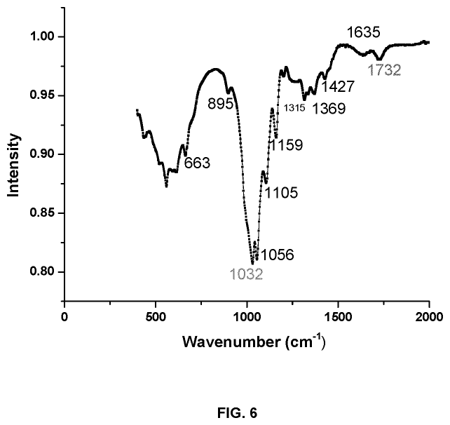

FIG. 6 shows a FTIR of crystalline cellulose nanoparticles. The peak associated with the —C—O—C— stretch of the β-1,4-glycosidic linkage in cellulose was observed at 1159 cm⁻¹ for Avicel® PH-101 in addition to absorption ranging from 1427 to 1032 cm⁻¹ as expected from cellulose. However, the distinct peak due —C—O— stretching of the carboxyl observed at 1732 cm⁻¹ in crystalline cellulose nanoparticles, but not in the Avicel®, indicating the formation of the carboxyl group on the crystalline cellulose nanoparticles. Such a result was in agreement with the solid-state ¹³C NMR spectrum of crystalline cellulose nanoparticles. It should be noted that the peak observed at 1732 cm⁻¹ has been observed for nanocrystalline cellulose (NCC) prepared by ammonium persulfate (Du et al., Bioresources, (2016) 11(2), 4017-4024). The absorption ratio A₁₇₃₂/A₁₀₃₂ between the carboxylic acid stretching band (1732 cm⁻¹) and the C—O stretching band of the chitin backbone (1032 cm⁻¹) can be used to estimate the carboxylic acid content of cellulose (Habibi et al. Cellulose, (2006) 13 (6), 679-687). This method estimated a carboxylic acid content of 0.074% for crystalline cellulose nanoparticles, compared with 0.1% obtained for cellulose whiskers resulting from HCl acid hydrolysis of tunicin and TEMPO-mediated oxidation (Habibi et al. supra).

Solid State NMR measurements were performed on a Bruker 11.7T Avance^{III} spectrometer equipped with a 4 mm VTN CPMAS probe at spinning rates of 8 and 10 kHz. ¹³C CP experiments employed a ¹H 90° pulse of 2.4 μs, followed by a 2.5 ms CP contact time using ramped field on ¹H (40 to 80 kHz) and 51 kHz field on ¹³C and composite-pulse ¹H decoupling using the SPINAL64 sequence with RF field of 94 kHz during acquisition. ¹³C CPMAS spectra were collected with 20150 scans on Avicel® or crystalline cellulose nanoparticles with a recycle delay of 3 s.

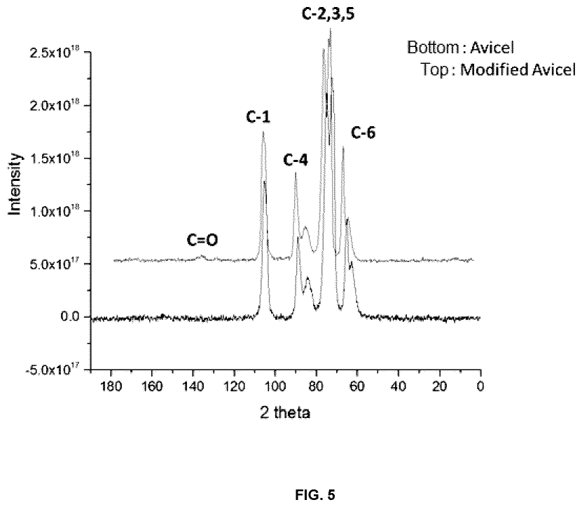

FIG. 5 depicts the solid-state NMR signature of crystalline cellulose nanoparticles compared with pristine Avicel® PH-101. In both cases, the whole spectrum shows the assignment of peaks to the carbons in a glucopyranose repeat unit. C-1 is a distinct peak whereas C-2, 3,5 peaks form a cluster. Both the C-4 and C-6 peaks have a pronounced shoulder, which could be considered as the amorphous region. However, the crystalline cellulose nanoparticles exhibit the sharper peaks and the ratios (peak height) of the peak C-2 and its shoulder and the peak C-6 and its shoulder increased appreciably. The sugar carbons in the Avicel® PH-101 cellulose were recently confirmed by Khazanov et al. supra and are shown in FIG. 5. The NMR spectrum of crystalline cellulose nanoparticles also shows a small peak at ˜135 ppm, indicating the formation of the carbonyl group (C═O) on their surface.

The foregoing disclosure of the exemplary embodiments has been presented for purposes of illustration and description. It is not intended to be exhaustive or to limit the claims to the precise forms disclosed. Many variations and modifications of the embodiments described herein will be apparent to one of ordinary skill in the art in light of the above disclosure. The scope of the invention is to be defined only by the claims appended hereto.

1. A process for producing spherical crystalline cellulose nanoparticles (SCCNPs) comprising contacting a cellulosic material with an effective amount of a reagent comprising potassium peroxomonosulfate (KHSO₅).

2. The process of claim 1, wherein said reagent is KHSO₅.0.5 KHSO₄. 0.5 K₂S 0₄.

3. The process of claim 2, wherein said cellulosic materials comprises cellulose fibers.

4. The process of claim 1, wherein said process is conducted in an aqueous medium.

5. The process of claim 5, wherein said reagent is present in the aqueous medium at a concentration ranging from about 0.20 M to about 1.25 M.

6. The process of claim 4, wherein the concentration of the cellulosic material in the aqueous medium ranges from about 0.1 to about 2.5 wt/vol %.

7. The process of claim 1, wherein the wt/wt ratio of the cellulosic material to the reagent is from about 1:1 to about 1:10.

8. The process of claim 1, wherein said process is conducted at a temperature ranging from about 40° C. to about 80° C.

9. The process of claim 1, wherein said SCCNPs is recovered.

10. The process of claim 9, wherein said SCCNPs is further dried.

11. Nanosized cellulose particles, wherein the said particles are substantially spherical crystalline chitin nanoparticles (SCCNPs) having an average diameter of about 3-10 nm or less as assessed by transmission electron microscope (TEM) micrographs.

12. Substantially spherical crystalline cellulose nanoparticles (SCCNPs) prepared by the process as defined in claim 1.

13. The process of claim 4, wherein the concentration of the cellulosic material in the aqueous medium ranges from about 0.1 to about 2.5 wt/vol %.

14. The process of claim 2, wherein the wt/wt ratio of the cellulosic material to the reagent is from about 1:1 to about 1:10.
